(19) United States
(12) Patent Application Publication
(10) Pub. No.: US 2023/0284320 A1
(43) Pub. Date: Sep. 7, 2023

(54) REFERENCE SIGNAL FOR UNCONNECTED MODE UES AND CONFIGURATION THEREOF

(71) Applicant: QUALCOMM Incorporated, San Diego, CA (US)

(72) Inventors: Huilin Xu, Temecula, CA (US); Peter Gaal, San Diego, CA (US); Wanshi Chen, San Diego, CA (US); Chenxi Hao, Beijing (CN); Xipeng Zhu, San Diego, CA (US); Yuchul Kim, San Diego, CA (US); Krishna Kiran Mukkavilli, San Diego, CA (US); Ozcan Ozturk, San Diego, CA (US); Jing Lei, San Diego, CA (US); Hwan Joon Kwon, San Diego, CA (US); Tingfang Ji, San Diego, CA (US)

(21) Appl. No.: 18/041,149

(22) PCT Filed: Oct. 16, 2020
(86) PCT No.: PCT/CN2020/121525

§ 371 Date: Feb. 9, 2023

(51) Int. Cl. H04W 76/20; H04W 24/08; H04W 68/02; H04L 27/26; H04W 76/30

(52) U.S. Cl. CPC H04W 76/20; H04W 24/08; H04W 68/02; H04L 27/26025; H04W 76/30

(57) ABSTRACT

This disclosure provides systems, methods, and devices for wireless communication that support use of a connected mode RS in an unconnected mode according to one or more aspects. In a first aspect, a method of wireless communication includes operating, by a user equipment (UE), in an unconnected mode. The method also includes determining, by the UE, reference signal (RS) configuration settings for the unconnected mode. The method includes monitoring, by the UE, for a reference signal based on the RS configuration settings. The method further includes receiving, by the UE, a RS transmission in the unconnected mode based on the RS configuration settings. Other aspects and features are also claimed and described.

### TECHNICAL FIELD

Aspects of the present disclosure relate generally to wireless communication systems, and more particularly, to Reference Signal (RS) operations for unconnected devices. Certain embodiments of the technology discussed below may enable a user equipment (UE) to use connected mode RSs in an unconnected mode, such as RRC idle or inactive modes.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes operating, by a user equipment (UE), in an unconnected mode. The method also includes determining, by the UE, reference signal (RS) configuration settings for the unconnected mode. The method includes monitoring, by the HE, for a reference signal based on the RS configuration settings. The method further includes receiving, by the UE, a RS transmission in the unconnected mode based on the RS configuration settings.

In an additional aspect of the disclosure, an apparatus configured for wireless communication is disclosed. The apparatus includes at least one processor, and a memory coupled to the at least one processor. The at least one processor is configured to operate, by a user equipment (UE), in an unconnected mode; determine, by the UE, reference signal (RS) configuration settings for the unconnected mode; monitor, by the UE, for a reference signal based on the RS configuration settings; and receive, by the UE, a RS transmission in the unconnected mode based on the RS configuration settings.

In an additional aspect of the disclosure, an apparatus configured for wireless communication is disclosed. The apparatus includes means for operating, by a user equipment (UE), in an unconnected mode; means for determining, by the UE, reference signal (RS) configuration settings for the unconnected mode; means for monitoring, by the UE, for a reference signal based on the RS configuration settings; and means for receiving, by the UE, a RS transmission in the unconnected mode based on the RS configuration settings.

In an additional aspect of the disclosure, a non-transitory computer-readable medium stores instructions that, when executed by a processor, cause the processor to perform operations including operating, by a user equipment (UE), in an unconnected mode; determining, by the UE, reference signal (RS) configuration settings for the unconnected mode; monitoring, by the UE, for a reference signal based on the RS configuration settings; and receiving, by the UE, a RS transmission in the unconnected mode based on the RS configuration settings.

In an additional aspect of the disclosure, a method of wireless communication includes determining, by a network entity, reference signal (RS) configuration settings for unconnected mode UEs; generating, by the network entity, a RS transmission for unconnected mode UEs; and transmitting, by the network entity, the RS transmission based on the RS configuration settings.

In an additional aspect of the disclosure, an apparatus configured for wireless communication is disclosed. The apparatus includes at least one processor, and a memory coupled to the at least one processor. The at least one processor is configured to determine, by a network entity, reference signal (RS) configuration settings for unconnected mode UEs; generate, by the network entity, a RS transmission for unconnected mode UEs; and transmit, by the network entity, the RS transmission based on the RS configuration settings.

In an additional aspect of the disclosure, an apparatus configured for wireless communication is disclosed. The apparatus includes means for determining, by a network entity, reference signal (RS) configuration settings for unconnected mode UEs; means for generating, by the network entity, a RS transmission for unconnected mode UEs; and means for transmitting, by the network entity, the RS transmission based on the RS configuration settings.

In an additional aspect of the disclosure, a non-transitory computer-readable medium stores instructions that, when executed by a processor, cause the processor to perform operations including determining, by a network entity, reference signal (RS) configuration settings for unconnected mode UEs; generating, by the network entity, a RS transmission for unconnected mode UEs; and transmitting, by the network entity, the RS transmission based on the RS configuration settings.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a diagram illustrating an example of information elements for reference signal (RS) information.

FIG. 4 is a block diagram illustrating an example wireless communication system that supports use of a connected mode RS in an unconnected mode according to one or more aspects.

FIG. 5 is a ladder diagram illustrating an example wireless communication system that supports use of a connected mode RS in an unconnected mode according to one or more aspects.

FIG. 6 is a ladder diagram illustrating an example wireless communication system that supports use of a connected mode RS in an unconnected mode according to one or more aspects.

FIG. 7 is a ladder diagram illustrating an example wireless communication system that supports use of a connected mode RS in an unconnected mode according to one or more aspects.

FIG. 8 is a block diagram illustrating bandwidths for a RS according to one or more aspects.

FIG. 9 is a block diagram illustrating an overlap of between a RS and another transmission according to one or more aspects.

FIG. 10 is a diagram illustrating an example wireless communication system that supports beam combining according to one or more aspects.

FIG. 11 is a flow diagram illustrating an example process that supports use of a connected mode RS in an unconnected mode according to one or more aspects.

FIG. 12 is a flow diagram illustrating an example process that supports use of a connected mode RS in an unconnected mode according to one or more aspects.

FIG. 13 is a block diagram of an example UE that supports use of a connected mode RS in an unconnected mode according to one or more aspects.

FIG. 14 is a block diagram of an example base station that supports use of a connected mode RS in an unconnected mode according to one or more aspects.

The Appendix provides further details regarding various aspects of this disclosure and the subject matter therein forms a part of the specification of this application.

Like reference numbers and designations in the various drawings indicate like elements.

### DETAILED DESCRIPTION

The detailed description set forth below, in connection with the appended drawings and appendix, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies, however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail device or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

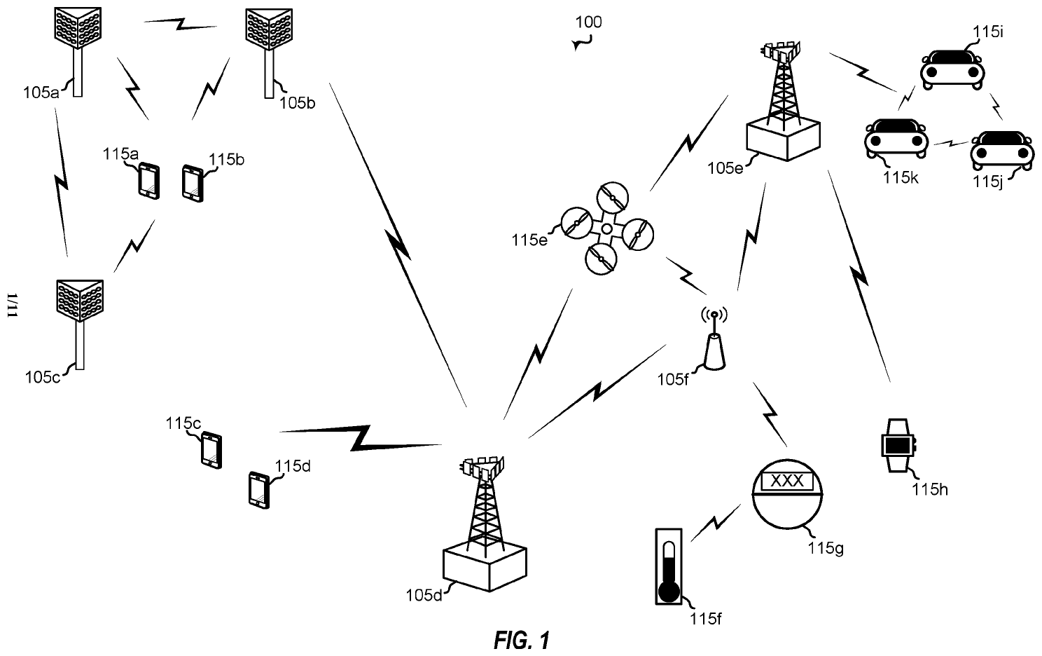

FIG. 1 is a block diagram illustrating details of an example wireless communication system according to one or more aspect. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multi cast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

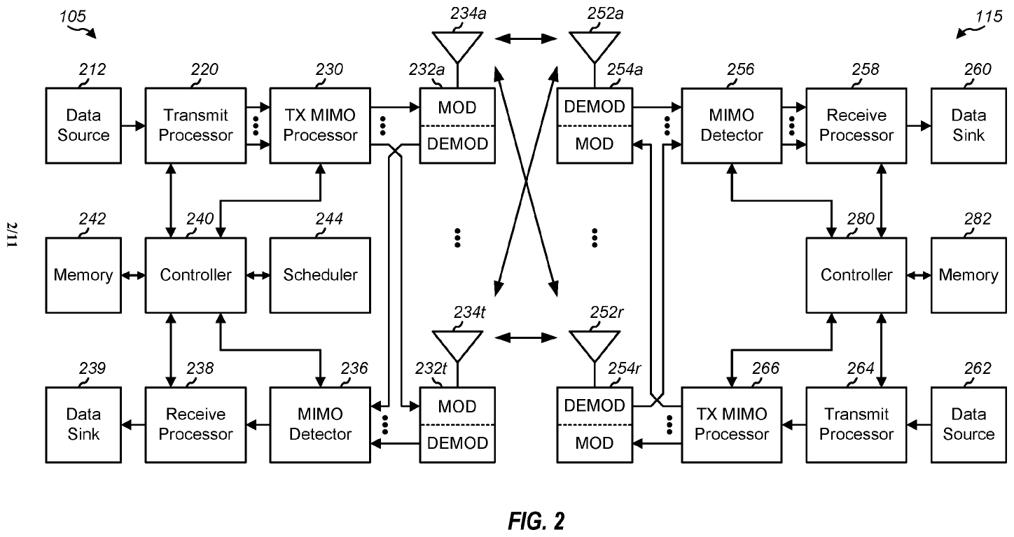

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115D operating in a service area of base station 105f which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

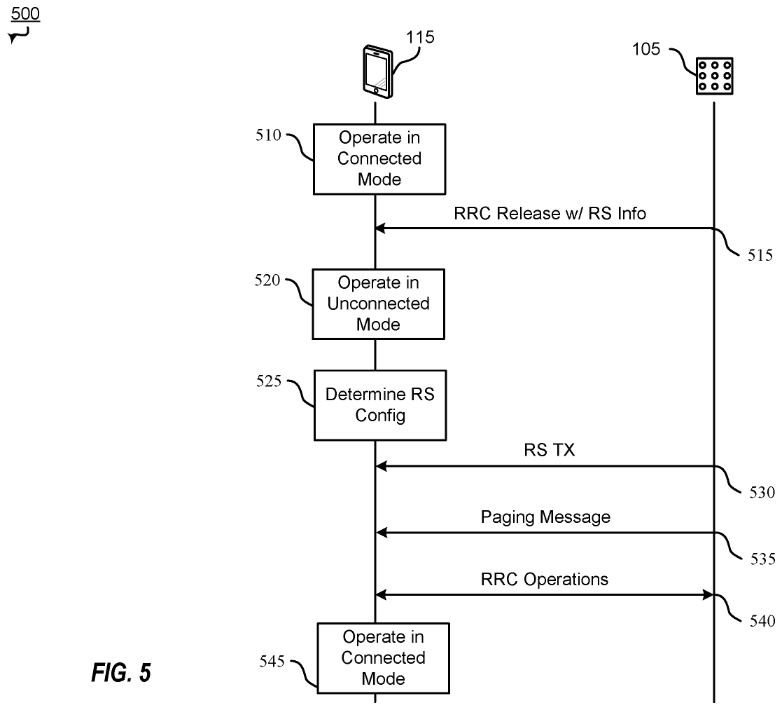

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 5-7, 13 and 14, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

It has been proposed for 5G NR operations in Release 17 to use a Tracking Reference Signal (TRS) or a Channel State Information Reference Signal (CSI-RS) already configured for connected mode UEs for idle or inactive mode UEs. The use of the TRS or the CSI-RS for unconnected mode UEs, such as idle and inactive mode UEs, may enable the UEs to help receive a page. Such reference signals are transmitted on multiple Synchronization Signal Block (SSB) beams, similar to paging messages.

Connected mode UEs normally use more narrow beams than SSB beams, and RSs may not be Quasi-Colocated (QCL'ed) with all SSBs transmitted in the cell. It has also been proposed to not have blind detection of the RS by unconnected mode UEs for tracking loop updates.

In some implementations, a network provides both configuration parameters and lifetime/availability of the RS. Due to the periodic behavior (paging scheme) of unconnected UE, a periodic RS will enable enhanced paging reception.

Additionally, or alternatively, aperiodic RS may be used. Aperiodic RS may be more helpful for transient behavior, e.g., UE is paged, such as by a paging indication (PI). In addition to or in alternative to the CSI-RS and TRS reference signals, a dedicated RS (e.g., UE specific RS or unconnected mode specific RS) may be used as the reference signal to help receive a paging message.

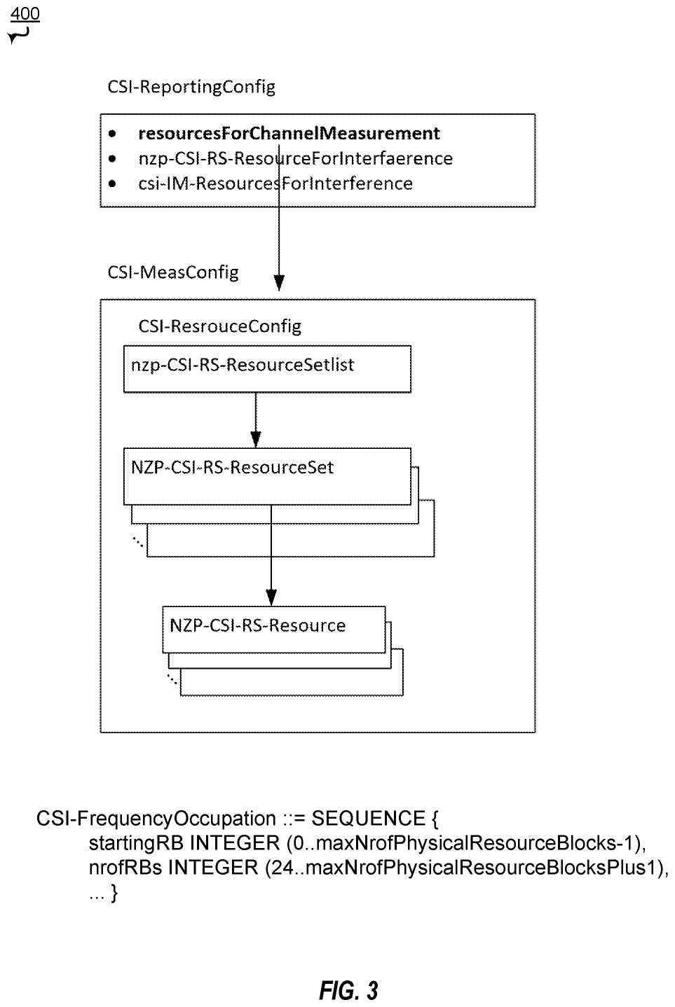

FIG. 3 illustrates an example of an information element for CSI-RS related information elements (IEs). In FIG. 3, a CSI-RS report configuration IE and a measurement configuration are shown. Such an information element may be used to report CSI-RS measurement information which may be determined based on a CSI-RS, such as a tracking reference signal (TRS). TRS is a special case of CSI-RS.

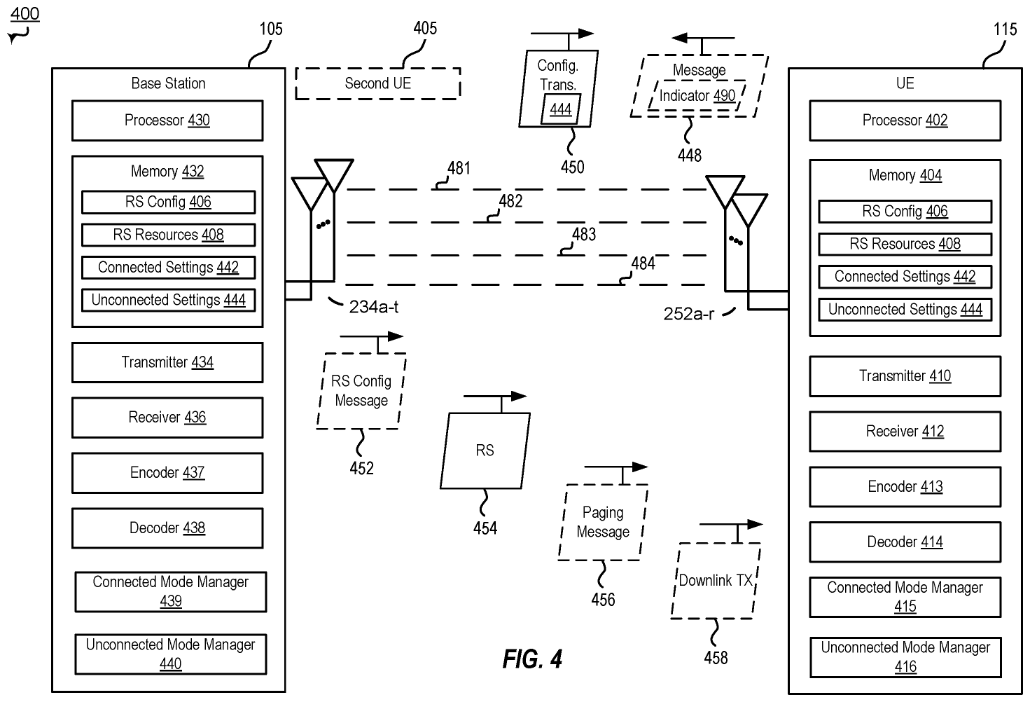

FIG. 4 illustrates an example of a wireless communications system 400 that supports enhanced unconnected mode operations in accordance with aspects of the present disclosure. In some examples, wireless communications system 400 may implement aspects of wireless communication system 100. For example, wireless communications system 400 may include multiple wireless communication devices and optionally a network entity. In the example of FIG. 4, the wireless communications system 400 includes a base station 105, a UE 115, and optionally a second UE 405. Enhanced unconnected mode operations may include use of a connected mode RS that is first configured to the connected mode UE in the unconnected mode. Use of the connected mode RS in the unconnected mode may reduce latency and increase throughput by increasing paging message effectiveness. Thus, network and device performance can be increased.

UE 115 and base station 105 may be configured to communicate via frequency bands, such as FR1 having a frequency of 410 to 7125 MHz, FR2 having a frequency of 24250 to 52600 MHz for mm-Wave, and/or one or more other frequency bands. It is noted that Sub-carrier spacing (SCS) may be equal to 15, 30, 60, or 120 kHz for some data channels. UE 115 and base station 105 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management, BWP switching functionality, or both. In some implementations, two or more CCs are quasi co-located, such that the CCs have the same beam and/or same symbol.

In some implementations, control information may be communicated via UE 115 and base station 105. For example, the control information may be communicated suing MAC-CE transmissions, RRC transmissions, SCI (sidelink control information), transmissions, another transmission, or a combination thereof.

UE 115, and optionally second UE 405, can include a variety of components (e.g., structural, hardware components) used for carrying out one or more functions described herein. For example, these components can includes processor 402, memory 404, transmitter 410, receiver 412, encoder, 413, decoder 414, connected mode manager 415, unconnected mode manager 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store RS configuration data 406, RS resource data 408, connected mode settings data 442, unconnected mode data 444, or a combination thereof, as further described herein.

The RS configuration data 406 includes or corresponds to data associated with or corresponding to a configuration for RS transmission. For example, the RS configuration data 406 may indicate one or more settings and/or parameters for RS transmission and feedback. Such settings and/or parameters for RS transmission and feedback may include SCS parameters, bandwidth parameters, QCL parameters, duration parameters, subset parameters, or a combination thereof, for one or more configured RSs. The RS resources data 408 includes or corresponds to data indicating or corresponding to transmission resources for RS transmissions and RS feedback.

The connected mode settings data 442 includes or corresponds to data associated with unconnected mode operations. The connected mode settings data 442 may include settings and/or conditions data for RS transmissions and RS reporting operations when in a connected mode.

The unconnected mode settings data 444 includes or corresponds to data associated with unconnected mode operations. The unconnected mode settings data 444 may include settings and/or conditions data for RS transmissions and RS reporting operations when in an unconnected mode.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both may include or correspond to one or more components of UE 115 described with reference to FIG. 2.

Encoder 413 and decoder 414 may be configured to encode and decode data for transmission. connected mode manager 415 may be configured to determine and perform connected mode operations. For example, connected mode manager 415 is configured to determine what resource or resources to use for RS transmission and RS feedback when operating in a connected mode, such as when and where to perform reference signal transmissions and feedback transmissions therefore. As another example, the connected mode manager 415 is configured to perform time and frequency tracking and measurement operations on RS transmissions.

Unconnected mode manager 416 may be configured to determine and perform connected mode operations. For example, unconnected mode manager 416 is configured to determine what resource or resources to use for RS transmission and RS feedback when operating in an unconnected mode, such as when and where to perform reference signal transmissions and feedback transmissions therefore. As another example, the unconnected mode manager 416 is configured to perform time and frequency tracking and measurement operations on RS transmissions.

Base station 105 includes processor 430, memory 432, transmitter 434, receiver 436, encoder 437, decoder 438, connected mode manager 439, unconnected mode manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store RS configuration data 406, RS resource data 408, connected mode settings data 442, unconnected mode data 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both may include or correspond to one or more components of base station 105 described with reference to FIG. 2.

Encoder 437, and decoder 438 may include the same functionality as described with reference to encoder 413 and decoder 414, respectively. Connected mode manager 439 may include similar functionality as described with reference to connected mode manager 415. Unconnected mode manager 440 may include similar functionality as described with reference to unconnected mode manager 416.

During operation of wireless communications system 400, base station 105 may determine that UE 115 has enhanced unconnected mode capability. For example, base station 105 may transmit a message 448 that includes an enhanced RS operation indicator 490 (e.g., a connected mode RS configuration for unconnected mode operation). Indicator 490 may indicate enhanced RS operation capability for unconnected modes or a particular type or mode of RS operation for unconnected modes. In some implementations, a base station 105 sends control information to indicate to UE 115 that enhanced RS operations for unconnected modes and/or a particular type of enhanced RS operations for unconnected modes is to be used. For example, in some implementations, message 448 (or another message, such as configuration transmission 450) is transmitted by the base station 105 or the network entity 405. The configuration transmission 450 may include or indicate to use enhanced RS operations for unconnected modes or to adjust or implement a setting of a particular type of enhanced RS operations for unconnected modes. For example, the configuration transmission 450 may include 444, as indicated in the example of FIG. 4, 442, or both.

During operation, devices of wireless communications system 400, perform enhanced RS operations for unconnected modes. For example, the wireless communication devices (e.g., a base station and UE) exchange transmissions via a downlink or uplink channel. In the example of FIG. 4, the base station 105 optionally transmits a RS configuration message 452 to the UE 115. The RS configuration message 452 may include or indicate a particular RS configuration for operation in a connected mode, unconnected modes, or both.

The UE 115 may receive the RS configuration message 452 and may determine the particular configuration of the RS indicated by the base station 105. The UE 115 may optionally determine the particular resource reserved by the base station 105 for RS transmission. The UE 115 may then monitor for a RS transmission, such as RS transmission 454, while in an unconnected mode based on the RS configuration message 452. For example, the base station 105 may transmit the RS transmission 454 to the UE 115 and optionally one or more other devices.

The UE 115 monitors for the RS transmission 454 while in the unconnected mode based on the RS configuration, and optionally one or more settings. The UE 115 may perform one or more operations based on the RS transmission 454 to select transmission and/or reception parameters for future operations.

In the example shown in FIG. 4, the base station 105 transmits a paging message 456 after the RS transmission 454. The paging message 456 includes or corresponds to a paging indication or wake-up message. The paging message 456 may indicate that the base station 105 has data for the UE and it may enable the LTE 115 to switch from the unconnected mode to the connected mode.

Once in the connected mode, the UE 115 and base station 105 may exchange communications. For example, the base station 105 may optionally send a downlink transmission 458 to the UE 115.

Accordingly, the UE 115 and base station 105 may be able to more effectively perform RS operations, that is to reuse connected mode RS signals for unconnected mode UEs or receive a dedicated RS for unconnected mode UEs. Thus, FIG. 4 describes enhanced RS operations for unconnected mode devices. Using enhanced RS operations may enable improvements when devices are operating in an unconnected mode, such as an idle mode or an inactive mode, and reduce network overhead. Performing enhanced RS operations for unconnected mode enables increased successful paging message reception and thus, enhanced UE and network performance by increasing throughput and reducing errors and latency.

UEs 5-7 illustrate examples of ladder diagrams for RS operations for unconnected mode UEs according to some aspects. Referring to FIG. 5, FIG. 5 is a ladder diagram 500 of RS operations for unconnected mode UEs according to some aspects. In the example of FIG. 5, the ladder diagram illustrates a UE 115 and a network entity, such as base station 105, where the UE was previously connected to the network entity.

At 510, the UE 115 operates in a connected mode with the base station 105 (such as a gNB). For example, the UE 115 is an RRC connected mode with base station 105. While in the connected mode the UE 115 may transmit and receive data to and from the base station 105. In some such implementations, the UE 115 may be configured with one or more RS and may receive RSs from the base station 105 in the connected mode.

At 515, the base station 105 transmits a RRC release message to the UE 115 which includes or indicates an RS configuration. For example, the base station 105 generates and transmits a RRC release message with RS availability information to the UE 115. The RS availability information may include or indicate a RS configuration for the UE 115 to use while in the unconnected mode. The RRC release message is configured to transition the UE 115 from the connected mode to an unconnected mode, such as an idle mode or an inactive mode. The RS configuration information may include settings, formats, transmission resources, etc., for the RS.

At 520, the UE 115 operates in the unconnected mode. For example, the UE 115 switches from the connected mode to an idle mode or an inactive mode responsive to the RRC release message.

At 525, the UE 115 determines a RS configuration for the unconnected mode based on the RS information. For example, the UE 115 determines a RS configuration for a connected mode RS to use while in the unconnected mode based on RS availability information included in the RRC release message.

At 530, the base station 105 transmits a RS to the UE 115. For example, the base station 105 generates and transmits a RS transmission to the UE 115 for time and frequency tracking and measurement operations. The RS may include a CSI-RS, a TRS, or a dedicated RS. In some implementations, the RS is sent to multiple devices, such as multiple UEs. In other implementations, the RS is sent to a single device.

At 535, the base station 105 transmits a paging message to the UE 115. For example, the base station 105 generates and transmits a paging message to the UE 115 which the UE 115 receives based on the RS transmission. To illustrate, UE 115 may determine a best beam or settings to use to monitor and receive the paging message based on the reference signal. The paging message may include or correspond to a wake-up message.

At 540, the base station 105 and UE 115 perform RRC operations. For example, the base station 105 and UE 115 exchange RRC message to switch the UE 115 from the unconnected mode to the connected mode.

At 545, the UE 115 operates in the connected mode with the base station 105. For example, the UE 115 switches from the idle or inactive mode to the RRC connected mode with the base station 105. While in the connected mode, the UE 115 may transmit and receive data to and from the base station 105. In some such implementations, the UE 115 may be configured with one or more RS and may receive RSs from the base station 105 in the connected mode. The RS or RSs an corresponding configurations thereof may be the same one or more RSs used by unconnected mode UEs.

Thus, in the example in FIG. 5, the UE performs RS operations in an unconnected mode based on configuration information received from the network entity while in a connected mode. That is, the UE receives a RS configuration in a RRC release message and uses the RS configuration while in the unconnected mode to receive a connected mode RS.

Referring to FIG. 6, FIG. 6 is a ladder diagram 600 of RS operations for unconnected mode UEs according to some aspects. In the example of FIG. 6, the ladder diagram illustrates a UE 115 and a network entity, such as base station 105, where the UE was previously connected to the network entity. As compared to example of FIG. 5, the RS configuration or indication thereof may be receive in a message that is separate from the RRC release message in the example of FIG. 6.

At 610, the UE 115 operates in a connected mode with the base station 105 (such as a gNB). For example, the UE 115 is an RRC connected mode with base station 105. While in the connected mode the UE 115 may transmit and receive data to and from the base station 105. In some such implementations, the UE 115 may be configured with one or more RS and may receive RSs from the base station 105 in the connected mode.

At 615, the base station 105 transmits RS configuration information to the UE 115. For example, the base station 105 generates and transmits a message with RS availability information to the UE 115. The RS availability information may include or indicate a RS configuration for the UE 115 to use while in the connected mode, the unconnected mode, or both.

At 620, the UE 115 determines a RS configuration for the unconnected mode based on the RS information. For example, the UE 115 determines a RS configuration for a connected mode RS to use while in the unconnected mode based on the RS availability information.

At 625, the base station 105 transmits a RRC release message to the UE 115. For example, the base station 105 generates and transmits a RRC release message configured to transition the UE 115 from the connected mode to an unconnected mode, such as an idle mode or an inactive mode.

At 630, the UE 115 operates in the unconnected mode. For example, the UE 115 switches from the connected mode to an idle mode or an inactive mode responsive to the RRC release message.

At 635, the base station 105 transmits a RS to the UE 115. For example, the base station 105 generates and transmits a RS transmission to the UE 115 for time and frequency tracking and measurement operations. The RS may include a CSI-RS, a TRS, or a dedicated RS. In some implementations, the RS is sent to multiple devices, such as multiple UEs. In other implementations, the RS is sent to a single device.

At 640, the base station 105 transmits a paging message to the UE 115. For example, the base station 105 generates and transmits a paging message to the UE 115 which the UE 115 receives based on the RS transmission. To illustrate, UE 115 may determine a best beam or settings to use to monitor and receive the paging message based on the reference signal. The paging message may include or correspond to a wake-up message.

At 645, the base station 105 and UE 115 perform RRC operations. For example, the base station 105 and UE 115 exchange RRC message to switch the UE 115 from the unconnected mode to the connected mode.

At 650, the UE 115 operates in the connected mode with the base station 105. For example, the UE 115 switches from the idle or inactive mode to the RRC connected mode with the base station 105. While in the connected mode, the UE 115 may transmit and receive data to and from the base station 105. In some such implementations, the UE 115 may be configured with one or more RS and may receive RSs from the base station 105 in the connected mode. The RS or RSs an corresponding configurations thereof may be the same one or more RSs used by unconnected mode UEs.

Thus, in the example in FIG. 6, the UE performs RS operations in an unconnected mode based on configuration information received from the network entity while in a connected mode. That is, the UE receives a RS configuration and uses the RS configuration while in the unconnected mode to receive a connected mode RS.

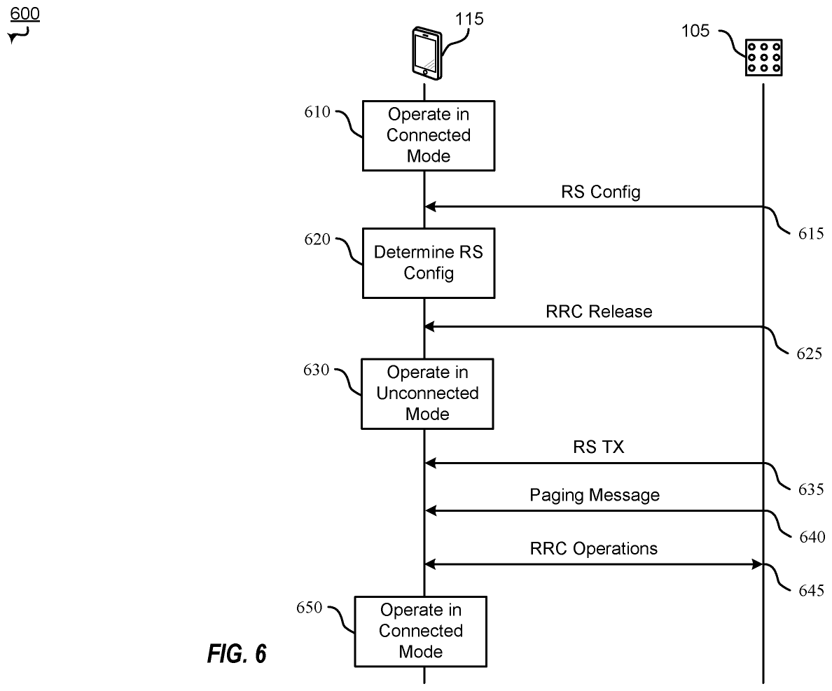

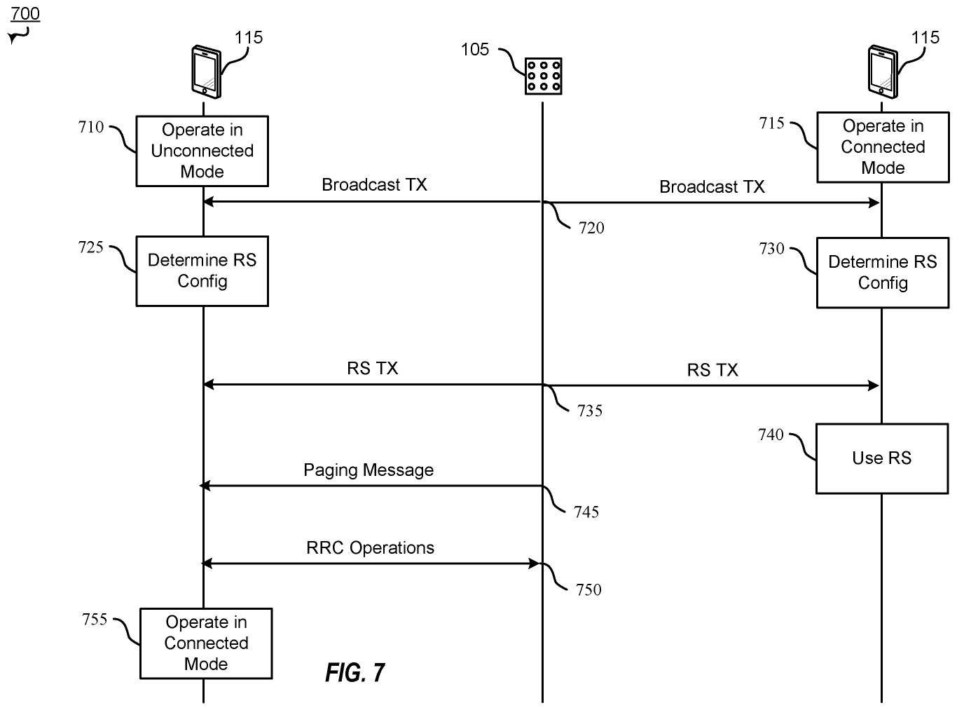

Referring to FIG. 7, FIG. 7 is a ladder diagram 700 of RS operations for unconnected mode UEs according to some aspects. In the example of FIG. 7, the ladder diagram illustrates multiple UEs, such as a first UE 115a and a second UE 115b, and a network entity, such as base station 105, where at least one UE was not previously connected to the network entity. As compared to examples of FIGS. 5 and 6, the RS configuration or indication thereof may be received in a broadcast message by a UE which is not connected to the network entity.

At 710, the first UE 115a operates in a unconnected mode. For example, the first UE 115a is an idle or inactive mode. While in the unconnected mode, the first UE 115a may attempt to monitor reference signals from one or more cells, such as the base station 105.

At 715, the second UE 115b operates in a connected mode with the base station 105 (such as a gNB). For example, the second UE 115b is an RRC connected mode with base station 105. While in the connected mode the second UE 115b may transmit and receive data to and from the base station 105. In some such implementations, the second UE 115b may be configured with one or more RS and may receive RSs from the base station 105 in the connected mode.

At 720, the base station 105 broadcasts RS configuration information to the UEs 115a and 115b. For example, the base station 105 generates and transmits a broadcast message with RS availability information to the UEs 115a and 115b. The RS availability information may include or indicate a RS configuration for the UEs 115a and 115b to use while in the connected mode, the unconnected mode, or both.

At 725, the first UE 115a determines a RS configuration for the unconnected mode based on the RS configuration information. For example, the first UE 115a determines a RS configuration for a connected mode RS to use while in the unconnected mode based on the RS availability information.

At 730, the second UE 115b determines a RS configuration for the connected mode based on the RS configuration information. For example, the second UE 115b determines a RS configuration for the connected mode RS to use while in the connected mode based on the RS availability information.

The RS configuration information of FIGS. 4-7 may optionally or further indicate which particular RS is available for unconnected mode UEs if multiple RS resources have been configured to the UE while in the connected mode. For example, a specific RS may be indicated (e.g., signaled) or a particular RS may be determined based on one or more parameters or conditions. To illustrate, a device may determine a particular RS or subset of RSs to use from multiple RSs based on a RS resource with the lowest ID, a number of N RS resources with the N lowest IDs, all configured RS resources etc. As another illustration for indication/signaling, the network may indicate a particular RS or subset of RSs based on a list of IDs for configured RSs. This indication may be in a RRC message (e.g., RRC release message) or another message. This indication may be sent with the RS configuration information (e.g., first RS configuration information) or may indicated by additional RS configuration information (e.g., first RS configuration information). The indicating information may include resource set ID or resource ID associated with the RS resource.

Additionally, or alternatively, the RS configuration information of FIGS. 4-7 may further indicate an expiration time during which the UE can assume the RS is available when the UE enters the unconnected mode. The expiration time can be indicated in units of seconds (e.g., milliseconds or micro seconds), slots, radio frames, paging cycles, etc. Alternatively, the expiration time can be indicated as zero or null, which may configure the RS to have an infinite duration or no expiration time.

At 735, the base station 105 transmits a RS to the UEs 115a and 115b For example, the base station 105 generates and transmits a RS transmission to the UEs 115a and 115b for time and frequency tracking and measurement operations. The RS may include a CSI-RS, a TRS, or a dedicated RS.

At 740, the second UE 115b uses the RS transmission. For example, the second UE 115b performs a measurement operation on the RS and/or compares the reference signal to a stored signal and transmits or receives data based on the RS and such operations.

At 745, the base station 105 transmits a paging message to the first UE 115a. For example, the base station 105 generates and transmits a paging message to the first UE 115a which the first UE 115a receives based on the RS transmission. To illustrate, the first UE 115a may determine a best beam or settings to use to monitor and receive the paging message based on the RS. The paging message may include or correspond to a wake-up message.

At 750, the base station 105 and first UE 115a perform RRC operations. For example, the base station 105 and first UE 115a exchange RRC messages to switch the first UE 115a from the unconnected mode to the connected mode.

At 755, the first UE 115a operates in the connected mode with the base station 105. For example, the first UE 115a switches from the idle or inactive mode to the RRC connected mode with the base station 105. While in the connected mode, the first UE 115a may transmit and receive data to and from the base station 105. In some such implementations, the first UE 115a may be configured with one or more RSs and may receive RSs from the base station 105 in the connected mode. The RS or RSs an corresponding configurations thereof may be the same one or more RSs used by unconnected mode UEs.

Thus, in the example in FIG. 7, the UE performs RS operations in an unconnected mode based on configuration information broadcasted by the network entity while the UE is in an unconnected mode. That is, the UE receives a RS configuration while not connected with the base station and uses the RS configuration while in the unconnected mode to receive a connected mode RS.

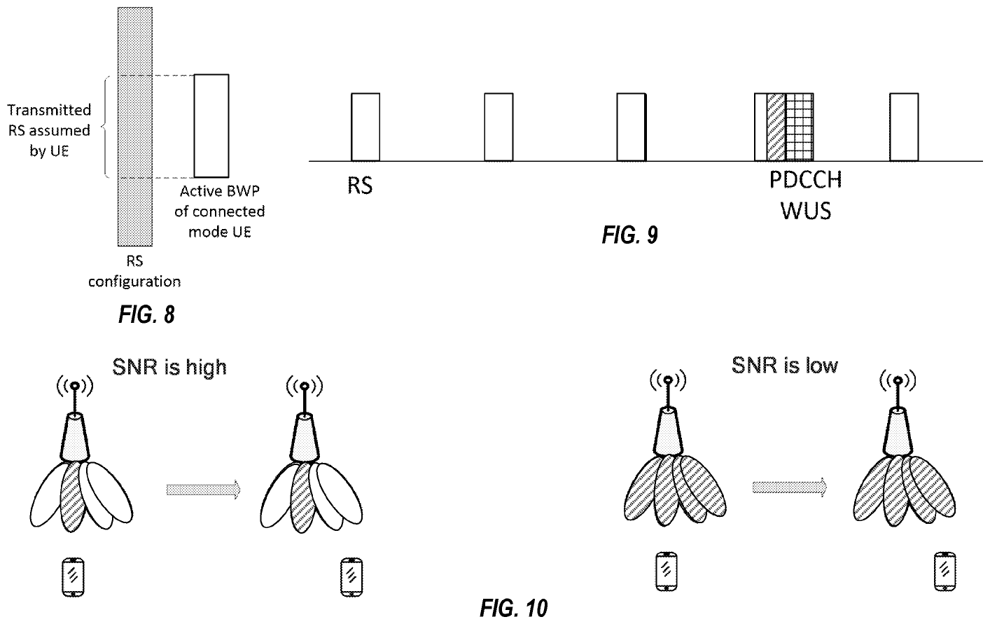

FIGS. 8-10 illustrate examples of diagrams for RS operations according to some aspects. Referring to FIG. 8, FIG. 8 is a diagram 800 illustrating bandwidths of RS and an active bandwidth part. In the example of FIG. 8, the diagram illustrates a bandwidth of a RS configuration and a bandwidth of an active bandwidth part for connected mode UEs.

As an illustrative example, during operation a UE may receive or determine a RS configuration having a first bandwidth as shown in FIG. 8. The UE may also receive or determine that an active BWP for connected mode UEs has a second bandwidth as shown in FIG. 8. In FIG. 8, the second bandwidth is smaller than the first bandwidth and overlaps a middle portion of the first bandwidth. A UE in an unconnected mode may determine that a bandwidth for a RS for UEs in an unconnected mode is the overlapped portion in some implementations, that is the overlapped portion between a bandwidth of the RS indicated by the RS configuration provided to the unconnected mode UE and a bandwidth of the active BWP of the connected mode UEs. In other implementations, the UE may determine the bandwidth for the RS for UEs in an unconnected mode is the full bandwidth of the RS configuration or some other portion thereof. Additional examples are provided below.

In some operating conditions or modes bandwidth settings of an original RS configuration for connected mode UEs may cause potential issues for UEs operating in an unconnected mode. For example, issues may arise when a lowest RB index is not used, a bandwidth of a step of 4 RBs is not used, or a bandwidth of the RS does not satisfy a threshold condition. To illustrate, a bandwidth of the RS may not be greater than or equal to 24 RBs for CSI-RS or not be greater than or equal to 52 RBs for TRS. Thus, when these parameters are determined by connected UEs active BWP bandwidth range, the UE and network may modify such parameters.

Regarding the step of 4 RBs issue, the UE and network may take a hose of different mitigation actions to modify the bandwidth of the RS. As one example, the devices may truncate the RS bandwidth such that the UEs (e.g., connected, unconnected, or both) monitor the RS in 4 RB grids.

As another example, the devices may determine to use the original RS configuration, and the RS is transmitted in the entire configured bandwidth of the RS. As yet another example, the device may modify RS configuration signaling to reduce a granularity for determining bandwidth. To illustrate, a granularity may be reduced from 4 RBs to 1 to provide a finer granularity.

As an additional example, the network may signal a BWP configuration of the associated BWP for the connected mode UE. Such information may enable the UEs in the unconnected mode to calculate the RS bandwidth monitored by the connected mode UEs.

Regarding bandwidth size issues, similar actions may be employed. To illustrate, when a bandwidth of the active BWP of the connected mode UE is less than 24 RBs, the associated CSI-RS may not be used. As another illustration, a bandwidth of the original RS configuration, which may be greater than or equal to 24 RBs, may be used. As yet another illustration, the RS configuration signaling may be modified to reduce a bandwidth of the original RS configuration to be less than 24 RBs when used by unconnected mode UEs. As an additional illustration, a network may provide an alternative bandwidth, such as by providing an alternative connected mode BWP configuration.

For TRS, when a bandwidth of the active BWP of the connected mode UE is less than 52 RBs, the associated TRS may not be used. In such implementations, a different RS may be used (e.g., CSI-RS or a dedicated RS). Alternatively, in other implementations the original RS configuration, which may greater than or equal to 52 RBs, may be used. In yet other implementations, the RS configuration signaling may be modified to reduce a bandwidth of the original RS configuration to be less than 52 RBs when used by unconnected mode UEs. In further implementations, a network may provide an alternative bandwidth, such as by providing an alternative connected mode BWP configuration.

Additionally, or alternatively, a SCS of the RS may be configured or determined by the devices. In some implementations, a first SCS of the RS in the associated BWP of the connected mode UEs is the same as a second SCS of the active BWP for unconnected mode UEs. A UE may be configured to expect to receive a RS with the same SCS as a SCS of its active BWP. In such implementations, the SCS of the RS may not be explicitly configured for the unconnected mode UEs.

In some implementations, a carrier index is included in the RS configuration for unconnected mode UEs. The carrier index may indicate the carrier on which the RS is transmitted. If a carrier index is not associated with the current serving cell, the RS can be used for neighbor cell measurement, or serving cell tracking and measurement after cell reselection to the carrier. In such implementations, a UE may start to monitor the RS associated with a carrier index other than that for the previous serving cell when UE camps on the cell associated with the carrier index.

Referring to FIG. 9, FIG. 9 is a diagram 900 illustrating an overlap between a RS and another transmission. In the example of FIG. 9, the diagram illustrates an overlap between a RS and a downlink transmission, such as a PDCCH or PDSCH. In a particular implementation, the PDCCH may be a paging DCI or paging signal, aka a page indication (PI) or a wake-up signal (WUS). The PI and the WUS may indicate whether the UE is paged in the next paging occasion (PO). After detecting the PI and/or the WUS, the UE decides whether the next PO needs to be monitored and/or processed. In a particular implementation, the PDSCH may be a PDSCH scheduled by the paging DCI or a PDSCH carrying system information block (SIB).

A network may be configured to take one or more actions when an overlap occurs to resolve the overlap. Alternatively, a network may determine schedules and adjust the schedules to avoid overlaps in the first place. For example, a base station may generate a RS configuration which does not result in RS overlaps.

If an overlap does occur, the network may configure devices to handle the overlap in one or more ways. In some implementations, the devices determine a RS is not transmitted if the configured RS occasion has an overlap with another transmission. In other implementations, the devices determine puncturing or rate matching of the downlink channel (i.e., PDCCH/PDSCH) around the RS transmission. In yet other implementations, the devices determine that both the RS and the downlink channel are transmitted. An advanced UE, such as one with multiple antennas, may be able to receive both the RS and the downlink channel even though the transmission at least partially overlaps in frequency and/or time.

Referring to FIG. 10, FIG. 10 is a diagram 1000 illustrating beam combining. In the example of FIG. 10, the diagram illustrates a first depiction of single beam use and a second depiction of beam combining/multiple beam use. Beam combining may be configured to be on, semi-statically configured, or dynamically used based on one or more conditions. For example, a quality condition (e.g., threshold) may be used to determine whether or not to use beam combining. The quality condition may include or correspond to a signal-to-noise ratio (SNR) condition, a signal-to-noise and interference ratio (SINR) condition, a Reference Signal Received Power (RSRP) condition, a Reference Signal Received Quality (RSRQ) condition, or a combination thereof.

In some implementations, when the quality condition is high and multi-beam combining is not used to increase the quality, the UE may use RSs associated with a highest quality SSB. In some such implementations, when the best SSB changes, the UE starts to use new RSs associated with the new best SSB.

In some implementations, when the quality condition is low and multi-beam combining is used to increase the quality, the UE may still use RSs associated with a prior best beam (e.g., highest quality SSB) and receive a paging message with the prior best beam that corresponds to the prior highest SSB.

During operation, a UE may move from cell to cell. When the UE moves from one cell (e.g., a first base station) to another cell (e.g., a second base station), the UE may continue to use the RS configuration from the old cell (e.g., the first base station). For example, when the unconnected mode UE moves to another cell, the UE switches to an RS or RSs associated with the new cell for tracking loop updates and measurement. In some such implementations, the UE may still use the previous RS or RSs in the old cell for neighbor cell measurement when the old cell (e.g., the first base station) becomes a neighbor cell after moving to the other cell (e.g., the second base station).

In some implementations, the RS configuration may include Quasi Co-Location (QCL) information. For example, a base station configures a QCL of the RS (e.g., an RS that is already configured to UE in connected mode) by a TCI state having a SSB as a source when this RS is configured to unconnected mode UEs.

In some such implementations, each RS resource is QCL'ed with only one SSB. This may mirror the settings of paging message, because each paging message transmission is associated with a single SSB.

In some other implementations, the base station transmits the RS in the wide SSB beam to unconnected UEs. Such transmission may be to match beams of RSs and beams of paging PDCCH and paging messages.

In general, pages for unconnected mode (e.g., idle/inactive mode) UEs are transmitted in SSB beams, but CSI-RS for connected mode UEs can be transmitted in narrower and more directional beams. In some implementations an unconnected mode UE is configured with multiple RSs QCL'ed with the same SSB. In some such implementations, all RSs QCL'ed with the same SSB have the same beam (e.g., same beam width and direction). This way, the UE may not perform extra finer beam management based on beam that is narrower than SSB beams.

For unconnected mode UEs, multiple RS resources associated with different SSBs should be configured. In some implementations, CSI-RS for connected mode UEs beam failure recovery or radio link failure (RLF) detection may have wide beam. A set of CSI-RS resources configured to the UE for beam failure recovery/RLF may be associated with all SSBs. Therefore, such RS and beams can be proper candidates for paging message reception operations for unconnected mode UEs. In a particular implementation RSs QCL'ed with all SSBs transmitted on the cell may be transmitted to have enough RSs QCL'ed for multiple connected UEs.

A network may determine and provide one or more other configurations for the RS for unconnected mode UEs. Such other configurations may include a repetition setting, a number of port settings, a periodicity setting, a frequency domain density setting, and one or more power control offset settings. The repetition setting may be set to “on” to allow UE to process more symbols of the RS (e.g., CSI-RS) QCL'ed with same SSB.

The number of ports setting network may reduce a number of the configured ports (e.g., to 1), such as when the RS is CSI-RS. For example, UE may assume a single port transmission of CSI-RS, e.g., port 0. TRS is only transmitted on a single port, so base station does not indicate port information for such RSs.

The periodicity settings may include a periodicityAndOffset IE. The network may adjust it to a relatively large periodicity to avoid downlink signal and power overheard. Currently the minimum periodicity is 4 slots for CSI-RS and 10 ms (e.g., less than or equal to 52 RBs) for TRS. In some implementations, high-density RSs (e.g., high-density CSI-RS) is suitable for time tracking. For example, single port CSI-RS and TRS may have the highest density of 3.

A first power offset setting may include powerControlOffset. When the RS is used for unconnected UE, the first power offset setting indicates a power difference between the RS and the associated paging PDCCH and paging PDSCH. A second power offset setting may include powerConfrolOffsetSS. When the RS is used for unconnected mode UEs, the second power offset setting indicates a power difference between the RS and the QCL'ed SSB.

In some implementations, the RS configuration information is sent during RRC release, such as indicated by a by a RRC Release message. In other implementations, the RS configuration information is sent in another message separate from the RRC Release communications (i.e., separate from the RRC release message).

In the examples of FIGS. 4-7, configuration parameters of the RS can be updated either by message or by rules defined in a network, a region, or a standard when a UE enters an unconnected mode (e.g., idle/inactive). As illustrative examples of such parameters which may be updated or adjusted are port information, periodicityAndOffset information, RS power Offset information, QCL information, or a combination thereof. To illustrate a number of ports setting may be changed to a sine port. As another illustration, the periodicity/offset setting may be increased. As yet another illustration, the RS power offset setting may be increased. As an additional illustration, the TCI state may be updated to indicate to use a SSB as a QCL source.

In some implementations, the RS configuration information may indicate which particular RS is available for unconnected mode UEs if multiple RS resources have been configured, such as while the UE is in the connected mode. For example, a specific RS may be indicated (e.g., signaled) by the RS configuration information or a particular RS may be determined based one or more parameters or conditions of a RS indicated by the RS configuration information. To illustrate, the network may indicate a particular RS or subset of RSs based on a list of IDs for configured RSs in the RS configuration information. This RS configuration information or indication may be in a RRC message (e.g., RRC release message) or another message. This indication may be sent with the RS configuration information (e.g., first RS configuration information which indicated the RS or RSs) or may indicated by additional RS configuration information (e.g., second RS configuration information). The indicating information may include a resource set ID or a resource ID associated with the RS resource. As another illustration for device determined, a device may determine a particular RS or subset of RSs to use from multiple RSs based on parameters of the RSs. For example, the device may use a RS resource (or RS resources) with the lowest ID. As another example, the device may use a RS resource (or RS resources) with a particular port setting (e.g., port 0), or a particular density setting, or both. Although two examples are shown, the device may use a particular setting of any of the parameters described above. Alternatively, all RS for unconnected mode UEs may be used.

Additionally, or alternatively, the RS configuration information may indicate an expiration for a RS or set of RSs. The expiration time may define a period during which the UE can assume that the RS is available to be used by the unconnected mode UEs and the expiration time may indicate this time from when the UE enters the unconnected mode. The expiration time can be indicated in any type of unit. For example, the expiration time can be indicated by a number of seconds (e.g., milliseconds or micro seconds), slots, radio frames, paging cycles, etc. Alternatively, the expiration time can be indicated as zero or null, which may configure the RS or RSs to have an infinite duration or no expiration time.

Additionally, or alternatively, one or more operations of FIGS. 4-10 may be added, removed, substituted in other implementations. For example, in some implementations, the example steps of FIGS. 5 and 7 may be used together. To illustrate, the broadcast of RS configuration of FIG. 6 may be used with the transmission of RS configuration information in RRC release messages of FIG. 5. As another example, some of the operations of FIGS. 8-10 may be used with the steps of any of FIGS. 4-7.

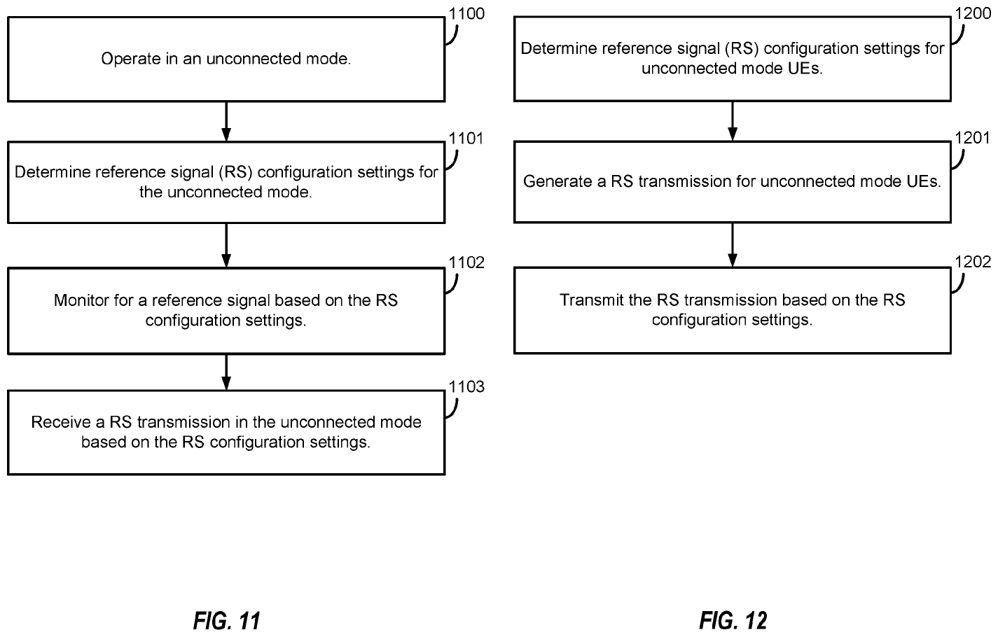

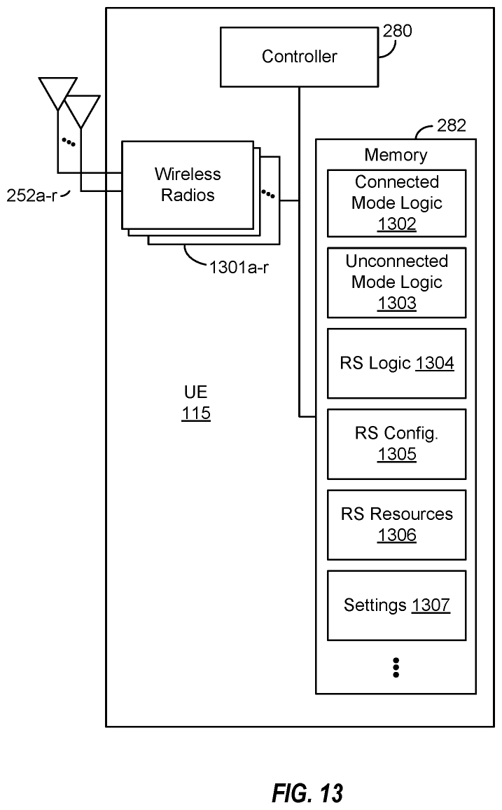

FIG. 11 is a flow diagram illustrating example blocks executed by a UE configured according to an aspect of the present disclosure. The example blocks will also be described with respect to UE 115 as illustrated in FIG. 13. FIG. 13 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1301a-r and antennas 252a-r. Wireless radios 1301a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 13, memory 282 stores Connected Mode logic 1302, Unconnected Mode logic 1303, RS Logic 1304, RS Configuration data 1305, RS Resource data 1306, and settings data 1307.

At block 1100, a wireless communication device, such as a UE, operates in an unconnected mode. For example, the UE 115 operates in an RRC idle mode or an RRC inactive mode, as described with reference to FIGS. 4-10. The unconnected mode may include or correspond to a RRC mode in which the UE is not connected to a base station.

At block 1101, the UE 115 determine reference signal (RS) configuration settings for the unconnected mode. For example, the UE 115 receives RS configuration information (e.g., 406) from a base station 105 using wireless radios 1301a-r and antennas 252a-r, as described with reference to FIGS. 4-10. The RS configuration information (e.g., 406) may be indicated by a RS configuration message 452, such as a RRC release message, another non-RRC release message, or a broadcast message. The RS configuration information may include or correspond to RS availability information. The unconnected mode manager 415, unconnected mode logic 1303, and/or RS logic 1304 of the UE 115 may determine the RS configuration indicated by the RS configuration information.

At block 1102, the UE 115 monitors for a reference signal based on the RS configuration settings. For example, the unconnected mode manager 416, unconnected mode logic 1203 and/or RS logic 1305 of the UE 115 uses wireless radios 1301a-r and antennas 252a-r to monitor for the RS transmission 454 based on the RS configuration information (e.g., 406/1305), as described with reference to FIGS. 4-10.

At block 1103, the UE 115 receives a RS transmission in the unconnected mode based on the RS configuration settings. For example, the UE 115 receives a RS transmission 454 in the unconnected mode based on the RS configuration settings using wireless radios 1301a-r and antennas 252a-r, as described with reference to FIGS. 4-10. The RS transmission 454 may be a RS for connected mode UEs or a dedicated RS for unconnected mode UEs. Receiving and processing the RS transmission 454 may enable the UE 115 to more effectively receive and process a subsequent message, such as a pagining message and/or may enable the UE 115 to more effectively transition to a connected mode.

The wireless communication device (e.g., UE or base station) may execute additional blocks (or the wireless communication device may be configured further perform additional operations) in other implementations. For example, the UE 115 may perform one or more operations described above. As another example, the UE 115 may perform one or more aspects as presented below.

In a first aspect, the RS transmission is a connected mode RS.

In a second aspect, alone or in combination with the first aspect, the RS transmission is a dedicated unconnected mode RS.

In a third aspect, alone or in combination with one or more of the above aspects, the unconnected mode is a RRC inactive mode or RRC idle mode.

In a fourth aspect, alone or in combination with one or more of the above aspects, the unconnected mode is a RRC inactive mode or RRC idle mode.

In a fifth aspect, alone or in combination with one or more of the above aspects, the RS transmission is a CSI-RS.

In a sixth aspect, alone or in combination with one or more of the above aspects, the RS transmission is a TRS.

In a seventh aspect, alone or in combination with one or more of the above aspects, the UE:

receives a paging message based on the RS transmission; and switches to a connected mode based on the paging message.

In an eighth aspect, alone or in combination with one or more of the above aspects, determining the RS configuration settings for the unconnected mode includes: receiving a broadcast message (e.g., RRC message, SIB, or Physical (PHY) layer message) from a network entity while operating in the unconnected mode or while connected to a second network entity; and determining the RS configuration settings based on the broadcast message.

In a ninth aspect, alone or in combination with one or more of the above aspects, the RS configuration corresponds to a RS configuration provided to the LE in a connected mode, and the UE, prior to operating in the unconnected mode: receives a RS configuration while in the connected mode from a network entity; receives a RS transmission while in the connected mode from the network entity; and receives a RRC release message from the network entity.

In a tenth aspect, alone or in combination with one or more of the above aspects, determining the RS configuration settings for the unconnected mode includes: determining the RS configuration settings based on the received RS settings information for the connected mode.

In an eleventh aspect, alone or in combination with one or more of the above aspects, the RS configuration for the unconnected mode has a limited duration.

In a twelfth aspect, alone or in combination with one or more of the above aspects, the RRC release message includes an RS availability indication, and wherein determining the RS configuration settings for the unconnected mode includes: determining the RS configuration settings based on the RS availability indication.

In a thirteenth aspect, alone or in combination with one or more of the above aspects, the UE: receives RS availability information in a message that is separate from the RRC release message, wherein determining the RS configuration settings for the unconnected mode includes: determining the RS configuration settings based on the RS availability information.

In a fourteenth aspect, alone or in combination with one or more of the above aspects, determining the RS configuration settings for the unconnected mode includes: determining the RS configuration settings based on UE settings information and the RS configuration provided to the UE in the connected mode.

In a fifteenth aspect, alone or in combination with one or more of the above aspects, the RS availability information indicates a particular RS resource from among a plurality of RS resources for connected mode UEs, a particular RS resource set from among a plurality of RS resource sets for connected mode UEs, an expiration time for the RS configuration for the unconnected mode, or a combination thereof.

In a sixteenth aspect, alone or in combination with one or more of the above aspects, the UE: receives a RS configuration update message indicating an adjustment to a RS configuration (e.g., either a changed parameter or complete configuration).

In a seventeenth aspect, alone or in combination with one or more of the above aspects, the UE: determines whether a RS configuration adjustment condition has been satisfied (e.g., entering unconnected mode); and adjusts the RS configuration based on the RS configuration adjustment condition being been satisfied.

In an eighteenth aspect, alone or in combination with one or more of the above aspects, a first sub-carrier spacing (SCS) of the RS transmission is the same as a second SCS of an active BWP of the UE in the unconnected mode.

In a nineteenth aspect, alone or in combination with one or more of the above aspects, the RS configuration information does not include sub-carrier spacing (SCS) information.

In a twentieth aspect, alone or in combination with one or more of the above aspects, the RS is received in an overlapping bandwidth between a first bandwidth of the RS indicated by the RS configuration settings and a second bandwidth of the active BWP of the unconnected UE (or of connected mode UEs).

In a twenty-first aspect, alone or in combination with one or more of the above aspects, the RS configuration information includes a carrier index information associated with a carrier on which the RS is transmitted.

In a twenty-second aspect, alone or in combination with one or more of the above aspects, the carrier index is not associated with current serving cell, and further comprising: monitoring the RS associated with the carrier index when the UE camps on a second cell associated with the carrier index.

In a twenty-third aspect, alone or in combination with one or more of the above aspects, the RS can be used for neighbor cell measurement, or serving cell tracking and measurement after cell reselection to the associated carrier.

In a twenty-fourth aspect, alone or in combination with one or more of the above aspects, the RS is a CSI-RS or a TRS monitored by a connected mode UE, wherein a starting resource block (RB) of the associated BWP of the connected mode UE is not in steps of 4, and wherein bandwidth of associated BWP of the connected mode UE (e.g., # of RBs) is not in steps of 4.

In a twenty-fifth aspect, alone or in combination with one or more of the above aspects, the UE modifies a bandwidth of a RS monitored by a connected mode UE to a bandwidth having 4 RB granularity and a starting RB having 4 RB granularity for the RS configuration for the unconnected mode.

In a twenty-sixth aspect, alone or in combination with one or more of the above aspects, the UE uses a RS configuration for a connected mode as the RS configuration for the unconnected mode, and the unconnected mode UE receives the RS based on the bandwidth indicated by the RS configuration.

In a twenty-seventh aspect, alone or in combination with one or more of the above aspects, the UE uses bandwidth granularity of less than 4 RBs for the RS configuration for the unconnected mode UE.

In a twenty-eighth aspect, alone or in combination with one or more of the above aspects, the UE receives bandwidth information of associated BWP of the connected mode UE for the RS configuration; and determines a bandwidth for the RS transmission based on the bandwidth information.

In a twenty-ninth aspect, alone or in combination with one or more of the above aspects, the RS is a CSI-RS monitored by a connected mode UE, and wherein a bandwidth of an associated BWP of the connected mode UE is less than 24 resource blocks (RBs)

In a thirtieth aspect, alone or in combination with one or more of the above aspects, using a RS configuration for a connected mode as the RS configuration for the unconnected mode, and the unconnected mode UE receives the RS based on the bandwidth indicated by the RS configuration.

In a thirty-first aspect, alone or in combination with one or more of the above aspects, modifying a bandwidth for the RS configuration to be less than 24 RBs.

In a thirty-second aspect, alone or in combination with one or more of the above aspects, the UE: receives bandwidth information of an associated BWP of the connected mode UE for the RS configuration; and determines a bandwidth for the RS transmission based on the bandwidth information.

In a thirty-third aspect, alone or in combination with one or more of the above aspects, the RS is a TRS monitored by a connected mode UE, and wherein a bandwidth of an associated BWP of the connected mode UE is less than 52 resource blocks (RBs).

In a thirty-fourth aspect, alone or in combination with one or more of the above aspects, the UE uses a RS configuration for a connected mode as the RS configuration for the unconnected mode, and the unconnected mode UE receives the RS based on the bandwidth indicated by the RS configuration.

In a thirty-fifth aspect, alone or in combination with one or more of the above aspects, the UE: receives bandwidth information of associated BWP of the connected mode UE for the RS configuration; and determines a bandwidth for the RS transmission based on the bandwidth information.

In a thirty-sixth aspect, alone or in combination with one or more of the above aspects, QCL information is indicated by TCI state, wherein each RS resource is QCL'ed with one SSB,

In a thirty-seventh aspect, alone or in combination with one or more of the above aspects, a RS resource QCL'ed with one SSB has the same beam direction, beam width or both.

In a thirty-eighth aspect, alone or in combination with one or more of the above aspects, a RS resource QCL'ed with one SSB has a first beam that is within a second beam of the SSB.

In a thirty-ninth aspect, alone or in combination with one or more of the above aspects, multiple RS are QCL'ed with a same SSB.

In a fortieth aspect, alone or in combination with one or more of the above aspects, multiple RS resources are configured for multiple SSBs, each RS resource corresponding to a different SSB.

In a forty-first aspect, alone or in combination with one or more of the above aspects, the RS is transmitted with a wide beam.

In a forty-second aspect, alone or in combination with one or more of the above aspects, multiple RSs are received by the UE, and wherein each RS that is QCL'ed with the same SSB has the same beam (e.g., beam width and direction).

In a forty-third aspect, alone or in combination with one or more of the above aspects, the RS transmission overlaps with a downlink transmission, and wherein the downlink transmission is a PDCCH transmission or a PDSCH transmission

In a forty-fourth aspect, alone or in combination with one or more of the above aspects, the PDCCH transmission is a paging DCI transmission or a page indication (PI), and wherein the PDSCH transmission is a transmission scheduled by a paging DCI or a system information block (SIB).

In a forty-fifth aspect, alone or in combination with one or more of the above aspects, the UE: determines that the RS transmission is not transmitted.

In a forty-sixth aspect, alone or in combination with one or more of the above aspects, the UE: determining that the downlink transmission is punctured by or rate matched around the RS transmission.

In a forty-seventh aspect, alone or in combination with one or more of the above aspects, the UE: determines that both the RS transmission and the downlink transmission are transmitted.

In a forty-eighth aspect, alone or in combination with one or more of the above aspects, the UE: moves, while in the unconnected mode, from a first cell to another cell; and switches to a second RS associated with the other cell for a tracking loop update and a measurement operation.

In a forty-ninth aspect, alone or in combination with one or more of the above aspects, the UE, after switching to the second RS: uses the RS associated with the first cell for neighbor cell measurement. In a fiftieth aspect, alone or in combination with one or more of the above aspects, the UE:

determines a quantity of a downlink channel condition; compares the quantity of the downlink channel condition to a threshold; and receives a second RS transmission from a single downlink transmission beam responsive to determining that the quantity of the downlink channel condition is greater than the threshold.

In a fifty-first aspect, alone or in combination with one or more of the above aspects, the UE: determines a quantity of a downlink channel condition; compares the quantity of the downlink channel condition to a threshold; and receives a second RS transmission from two or more downlink transmission beams responsive to determining that the quantity of the downlink channel condition is less than the threshold.

In a fifty-second aspect, alone or in combination with one or more of the above aspects, the UE: determines a quantity of a downlink channel condition for a downlink transmission beam associated with each SSB; compares the quantities of the downlink channel conditions associated with more than one SSB to determine a highest quantity of the downlink channel condition; and switches to/selects a particular SSB corresponding to the highest determined quantity of the downlink channel condition.

In a fifty-third aspect, alone or in combination with one or more of the above aspects, the quantity of the downlink channel condition includes SINR, SNR, RSRP, RSRQ, or RS SI.

In a fifty-fourth aspect, alone or in combination with one or more of the above aspects, the RS configuration includes a repetition setting, a number of port settings, a periodicity setting, a frequency domain density setting, and a power control offset settings.

In a fifty-fifth aspect, alone or in combination with one or more of the above aspects, the repetition setting in the RS configuration is set to on.

In a fifty-sixth aspect, alone or in combination with one or more of the above aspects, the number of port setting in the RS configuration is set to 1.

Accordingly, wireless communication devices may use a connected mode RS in an unconnected mode according to one or more aspects operations. By performing enhanced unconnected mode RS operations, throughput and reliability may be increased and such operations may enable enhancements when operating in unconnected modes.

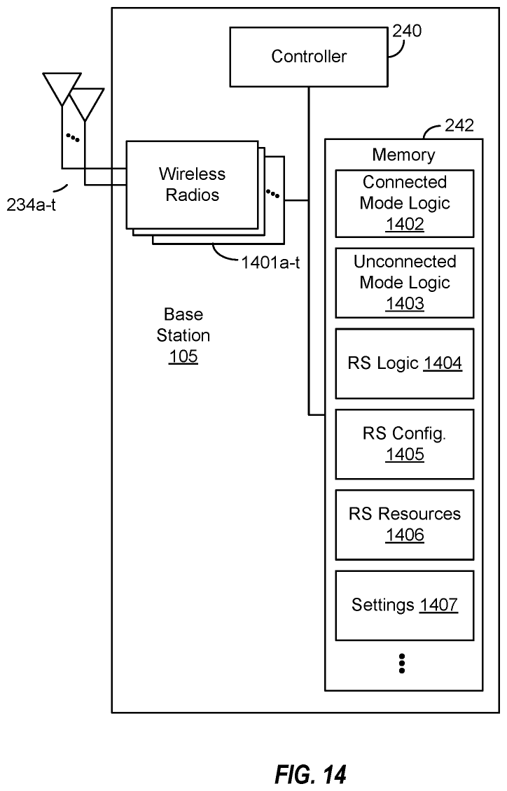

FIG. 12 is a flow diagram illustrating example blocks executed by network entity, such as a base station, configured according to an aspect of the present disclosure. The example blocks will also be described with respect to base station 105 as illustrated in FIG. 14. FIG. 14 is a block diagram illustrating base station 105 configured according to one aspect of the present disclosure. Base station 105 includes the structure, hardware, and components as illustrated for base station 105 of FIGS. 2 and/or 4. For example, base station 105 includes controller/processor 280, which operates to execute logic or computer instructions stored in memory 282, as well as controlling the components of base station 105 that provide the features and functionality of base station 105. Base station 105, under control of controller/processor 280, transmits and receives signals via wireless radios 1401a-t and antennas 234a-t. Wireless radios 1401a-t includes various components and hardware, as illustrated in FIG. 2 for base station 105, including modulator/demodulators 232a-r, MIMO detector 236, receive processor 238, transmit processor 220, and TX MIMO processor 230. As illustrated in the example of FIG. 14, memory 282 stores Connected Mode logic 1402, Unconnected Mode logic 1403, RS Logic 1404, RS Configuration data 1405, RS Resource data 1406, and settings data 1407.

At block 1200, a wireless communication device, such as a base station 105, determines reference signal (RS) configuration settings for unconnected mode UEs. For example, the Unconnected Mode manager 440, the Unconnected Mode Logic 1303, and/or the RS Logic 1304 of the base station 105 determines RS configuration information for unconnected mode UEs, as described with reference to FIGS. 4-10. The Unconnected Mode manager 440, the Unconnected Mode Logic 1303, and/or the RS Logic 1304 of the base station 105 may adjust existing RS settings to generate the RS configuration information for unconnected mode UE or may generate the RS configuration information for unconnected mode UE based on one or more network conditions and/or rules.

At block 1201, the base station 105 generates a RS transmission for unconnected mode UEs. For example, the Unconnected Mode manager 440, the Unconnected Mode Logic 1303, and/or the RS Logic 1304 of the base station 105 generates the RS transmission 454 for unconnected mode UEs using the RS configuration settings for unconnected mode UEs, as described with reference to FIGS. 4-10. To illustrate, the RS Logic 1304 of the base station 105 may adjust parameters of an existing RS or generate a new RS according to RS parameters indicated by the RS configuration settings. The RS may be for unconnected mode UEs only or unconnected mode UEs and connected mode UEs.

At block 1202, the base station 105 transmits the RS transmission based on the RS configuration settings. For example, the Unconnected Mode manager 440, the Unconnected Mode Logic 1303, and/or the RS Logic 1304 of the base station 105 transmits the RS transmission 454 according to the RS configuration (e.g., 444/1306) using wireless radios 1401a-t and antennas 234a-t, as described with reference to FIGS. 4-10. To illustrate, the RS Logic 1304 of the base station 105 may adjust transmission parameters based on the RS configuration settings. The RS transmission 454 may be for unconnected mode UEs only or unconnected mode UEs and connected mode UEs. The RS transmission 454 may include or correspond to a PDCCH transmission and/or a PDSCH transmission.

The network entity (e.g., base station 105) may execute additional blocks (or the network entity may be configured further perform additional operations) in other implementations. For example, the base station 105 may perform one or more operations described above. As another example, the base station 105 may perform one or more aspects as presented below.

In a first aspect, the RS transmission is a connected mode RS.

In a second aspect, alone in combination with the first aspect, the RS transmission is a dedicated unconnected mode RS.

In a third aspect, alone in combination with one or more of the above aspects, the unconnected mode is a RRC inactive mode or RRC idle mode.

In a fourth aspect, alone in combination with one or more of the above aspects, the RS transmission is a CSI-RS.

In a fifth aspect, alone in combination with one or more of the above aspects, the RS transmission is a TRS.

In a sixth aspect, alone in combination with one or more of the above aspects, the network entity (e.g., base station 105): transmits a paging message based on the RS transmission; and transitions a particular UE from the unconnected mode to a connected mode based on the paging message.

In a seventh aspect, alone in combination with one or more of the above aspects, the network entity (e.g., base station 105): transmits a broadcast message indicating the RS configuration settings.

In an eighth aspect, alone in combination with one or more of the above aspects, the network entity: transmits a RS configuration message indicating the RS configuration settings; transmits a RS transmission; and transmits a RRC release message.

In a ninth aspect, alone in combination with one or more of the above aspects, determining the RS configuration settings for the unconnected mode includes: determining the RS configuration settings based on RS settings information for a connected mode.

In a tenth aspect, alone in combination with one or more of the above aspects, the RS configuration for the unconnected mode has a limited duration.

In eleventh aspect, alone in combination with one or more of the above aspects, the RRC release message includes an RS availability indication, and wherein determining the RS configuration settings for the unconnected mode includes: determining the RS configuration settings based on the RS availability indication.

In a twelfth aspect, alone in combination with one or more of the above aspects, the network entity: transmits RS availability information in a message that is separate from the RRC release message, wherein determining the RS configuration settings for the unconnected mode includes: determining the RS configuration settings based on the RS availability information.

In a thirteenth aspect, alone in combination with one or more of the above aspects, determining the RS configuration settings for the unconnected mode includes: determining the RS configuration settings based on network entity settings information and the RS configuration provided to devices in a connected mode.

In a fourteenth aspect, alone in combination with one or more of the above aspects, the RS availability information indicates a particular RS resource from among a plurality of RS resources for connected mode devices, a particular RS resource set from among a plurality of RS resource sets for connected mode devices, an expiration time for the RS configuration for the unconnected mode, or a combination thereof.

In a fifteenth aspect, alone in combination with one or more of the above aspects, the network entity: transmits a RS configuration update message indicating an adjustment to a RS configuration.

In a sixteenth aspect, alone in combination with one or more of the above aspects, the network entity: determines whether a RS configuration adjustment condition has been satisfied; and adjusts the RS configuration based on the RS configuration adjustment condition being been satisfied.

In a seventeenth aspect, alone in combination with one or more of the above aspects, a first sub-carrier spacing (SCS) of the RS transmission is the same as a second SCS of an active BWP of devices in the unconnected mode.

In an eighteenth aspect, alone in combination with one or more of the above aspects, the RS configuration information does not include sub-carrier spacing (SCS) information.

In a nineteenth aspect, alone in combination with one or more of the above aspects, the RS is received in an overlapping bandwidth between a first bandwidth of the RS indicated by the RS configuration settings and a second bandwidth of the active BWP of an unconnected device (or of connected mode devices).

In a twentieth aspect, alone in combination with one or more of the above aspects, the RS configuration information includes a carrier index information associated with a carrier on which the RS is transmitted.

In a twenty-first aspect, alone in combination with one or more of the above aspects, the RS is a CSI-RS or a TRS monitored by a connected mode device, wherein a starting resource block (RB) of the associated BWP of the connected mode device is not in steps of 4, and wherein bandwidth of associated BWP of the connected mode device is not in steps of 4.

In a twenty-second aspect, alone in combination with one or more of the above aspects, the network entity modifies a bandwidth of a RS monitored by a connected mode device to a bandwidth having 4 RB granularity and a starting RB having 4 RB granularity for the RS configuration for the unconnected mode.

In a twenty-third aspect, alone in combination with one or more of the above aspects, using a RS configuration for a connected mode as the RS configuration for the unconnected mode.

In a twenty-fourth aspect, alone in combination with one or more of the above aspects, using bandwidth granularity of less than 4 RBs for the RS configuration for the unconnected mode UE.

In a twenty-fifth aspect, alone in combination with one or more of the above aspects, the network entity: transmits bandwidth information of an associated BWP of the connected mode UE for the RS configuration; and determines a bandwidth for the RS transmission based on the bandwidth information.

In a twenty-sixth aspect, alone in combination with one or more of the above aspects, the RS is a CSI-RS monitored by a connected mode device, and wherein a bandwidth of an associated BWP of the connected mode UE is less than 24 resource blocks (RBs)

In a twenty-seventh aspect, alone in combination with one or more of the above aspects, the network entity uses a RS configuration for a connected mode as the RS configuration for the unconnected mode, and the unconnected mode device receives the RS based on the bandwidth indicated by the RS configuration.

In a twenty-eighth aspect, alone in combination with one or more of the above aspects, the network entity modifies a bandwidth for the RS configuration to be less than 24 RBs.

In a twenty-ninth aspect, alone in combination with one or more of the above aspects, the network entity: transmits bandwidth information of an associated BWP of the connected mode device for the RS configuration; and determines a bandwidth for the RS transmission based on the bandwidth information.

In a thirteenth aspect, alone in combination with one or more of the above aspects, the RS is a TRS monitored by a connected mode device, and wherein a bandwidth of an associated BWP of the connected mode UE is less than 52 resource blocks (RBs)

In a thirty-first aspect, alone in combination with one or more of the above aspects, the network entity uses a RS configuration for a connected mode as the RS configuration for the unconnected mode, and the unconnected mode device receives the RS based on the bandwidth indicated by the RS configuration.

In a thirty-second aspect, alone in combination with one or more of the above aspects, the network entity: transmits bandwidth information of an associated BWP of the connected mode device for the RS configuration; and determines a bandwidth for the RS transmission based on the bandwidth information.

In a thirty-third aspect, alone in combination with one or more of the above aspects, QCL information is indicated by TCI state, wherein each RS resource is QCL'ed with one SSB,

In a thirty-fourth aspect, alone in combination with one or more of the above aspects, a RS resource QCL'ed with one SSB has the same beam direction, beam width or both.

In a thirty-fifth aspect, alone in combination with one or more of the above aspects, a RS resource QCL'ed with one SSB has a first beam that is within a second beam of the SSB.

In a thirty-sixth aspect, alone in combination with one or more of the above aspects, multiple RS are QCL'ed with a same SSB.

In a thirty-seventh aspect, alone in combination with one or more of the above aspects, multiple RS resources are configured for multiple SSBs, each RS resource corresponding to a different SSB.

In a thirty-eighth aspect, alone in combination with one or more of the above aspects, the RS is transmitted with a wide beam.

In a thirty-ninth aspect, alone in combination with one or more of the above aspects, multiple RSs are received by the UE, and wherein each RS that is QCL'ed with the same SSB has the same beam.

In a fortieth aspect, alone in combination with one or more of the above aspects, the RS transmission overlaps with a downlink transmission, and wherein the downlink transmission is a PDCCH transmission or a PDSCH transmission

In a forty-first aspect, alone in combination with one or more of the above aspects, the PDCCH transmission is a paging DCI transmission or a page indication (PI), and wherein the PDSCH transmission is a transmission scheduled by a paging DCI or a system information block (SIB).

In a forty-second aspect, alone in combination with one or more of the above aspects, the network entity: determines that the downlink transmission is punctured by or rate matched around the RS transmission.

In a forty-third aspect, alone in combination with one or more of the above aspects, the network entity: determines to transmit the RS transmission and the downlink transmission are transmitted.

In a forty-fourth aspect, alone in combination with one or more of the above aspects, the RS configuration includes a repetition setting, a number of port settings, a periodicity setting, a frequency domain density setting, and a power control offset settings.

In a forty-fifth aspect, alone in combination with one or more of the above aspects, the network entity adjusts the repetition setting in the RS configuration to on.

In a forty-sixth aspect, alone in combination with one or more of the above aspects, the network entity reduces a number of ports configured for the RS to 1.

Accordingly, wireless communication devices may use a connected mode RS in an unconnected mode according to one or more aspects operations. By performing enhanced unconnected mode RS operations, throughput and reliability may be increased and such operations may enable enhancements when operating in unconnected modes.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-14 include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication comprising:
operating, by a user equipment (UE), in an unconnected mode;
determining, by the UE, reference signal (RS) configuration settings for the unconnected mode;
monitoring, by the UE, for a reference signal based on the RS configuration settings; and
receiving, by the UE, a RS transmission in the unconnected mode based on the RS configuration settings.

2. The method of claim 1, wherein the RS transmission is a connected mode RS.

3. The method of claim 1, wherein the RS transmission is a dedicated unconnected mode RS.

4. The method of claim 1, wherein the unconnected mode is a RRC inactive mode or RRC idle mode.

5. The method of claim 1, wherein the RS transmission is a CSI-RS.

6. The method of claim 5, wherein the RS transmission is a TRS.

7. The method of claim 1, further comprising:
receiving, by the UE, a paging message based on the RS transmission; and
switching, by the UE, from the unconnected mode to a connected mode based on the paging message.

8. The method of claim 1, wherein determining the RS configuration settings for the unconnected mode includes:
receiving a broadcast message from a network entity while operating in the unconnected mode or while connected to a second network entity; and
determining the RS configuration settings based on the broadcast message.

9. The method of claim 1, wherein the RS configuration corresponds to a RS configuration provided to the UE in a connected mode, and further comprising, prior to operating in the unconnected mode:
receiving, by the UE, a RS configuration while in the connected mode from a network entity;
receiving, by the UE, a RS transmission while in the connected mode from the network entity; and
receiving, by the UE, a RRC release message from the network entity.

10. The method of claim 9, wherein determining the RS configuration settings for the unconnected mode includes:
determining the RS configuration settings based on the received RS settings information for the connected mode.

11. The method of claim 9, wherein the RS configuration for the unconnected mode has a limited duration.

12. The method of claim 9, wherein the RRC release message includes an RS availability indication, and wherein determining the RS configuration settings for the unconnected mode includes: determining the RS configuration settings based on the RS availability indication.

13. The method of claim 9, further comprising:
receiving, by the UE, RS availability information in a message that is separate from the RRC release message, wherein determining the RS configuration settings for the unconnected mode includes: determining the RS configuration settings based on the RS availability information.

14. The method of claim 13, wherein the RS availability information indicates a particular RS resource from among a plurality of RS resources for connected mode UEs, a particular RS resource set from among a plurality of RS resource sets for connected mode UEs, an expiration time for the RS configuration for the unconnected mode, or a combination thereof.

15. The method of claim 9, wherein determining the RS configuration settings for the unconnected mode includes: determining the RS configuration settings based on UE settings information and the RS configuration provided to the UE in the connected mode.

16. The method of claim 9, further comprising:
receiving, by the UE, a RS configuration update message indicating an adjustment to a RS configuration.

17. The method of claim 9, further comprising:
determining, by the UE, whether a RS configuration adjustment condition has been satisfied; and
adjusting, by the UE, the RS configuration based on the RS configuration adjustment condition being been satisfied.

18. The method of claim 1, wherein a first sub-carrier spacing (SCS) of the RS transmission is the same as a second SCS of an active BWP of connected mode UEs.

19. The method of claim 1, further comprising:
receiving, by the UE, a RS configuration information indicating the RS configuration, wherein the RS configuration information does not include sub-carrier spacing (SCS) information.

20. The method of claim 1, wherein the RS is received in an overlapping bandwidth between a first bandwidth of the RS indicated by the RS configuration settings and a second bandwidth of an active BWP of the unconnected mode UE.

21. The method of claim 1, further comprising:
receiving, by the UE, a RS configuration information indicating the RS configuration, wherein the RS configuration information includes a carrier index information associated with a carrier on which the RS is transmitted.

22. The method of claim 21, wherein the carrier index is not associated with current serving cell, and further comprising:
monitoring, by the UE, the RS associated with the carrier index when the UE camps on a second cell associated with the carrier index.

23. The method of claim 22, wherein the RS can be used for neighbor cell measurement, or serving cell tracking and measurement after cell reselection to the associated carrier.

24. The method of claim 1, wherein the RS is a CSI-RS or a TRS monitored by a connected mode UE, wherein a starting resource block (RB) of an associated BWP of the connected mode UE is not in steps of 4, and wherein bandwidth of associated BWP of the connected mode UE is not in steps of 4.

25. The method of claim 24, further comprising modifying a bandwidth of a RS monitored by a connected mode UE to a bandwidth having 4 RB granularity and a starting RB having 4 RB granularity for the RS configuration for the unconnected mode.

26. The method of claim 24, further comprising using a RS configuration for a connected mode as the RS configuration for the unconnected mode, and the unconnected mode UE receives the RS based on the bandwidth indicated by the RS configuration.

27. The method of claim 24, further comprising using bandwidth granularity of less than 4 RBs for the RS configuration for the unconnected mode UE.

28. The method of claim 24, further comprising:
receiving, by the UE, bandwidth information of associated BWP of the connected mode UE for the RS configuration; and
determining, by the UE, a bandwidth for the RS transmission based on the bandwidth information.

29. The method of claim 1, wherein the RS is a CSI-RS monitored by a connected mode UE, and wherein a bandwidth of an associated BWP of the connected mode UE is less than 24 resource blocks (RBs).

30. The method of claim 29, further comprising using a RS configuration for a connected mode as the RS configuration for the unconnected mode, and the unconnected mode UE receives the RS based on the bandwidth indicated by the RS configuration.

31. The method of claim 29, further comprising modifying a bandwidth for the RS configuration to be less than 24 RBs.

32. The method of claim 29, further comprising:
receiving, by the UE, bandwidth information of an associated BWP of the connected mode UE for the RS configuration; and
determining, by the UE, a bandwidth for the RS transmission based on the bandwidth information.

33. The method of claim 1, wherein the RS is a TRS monitored by a connected mode UE, and wherein a bandwidth of an associated BWP of the connected mode UE is less than 52 resource blocks (RBs).

34. The method of claim 33, further comprising using a RS configuration for a connected mode as the RS configuration for the unconnected mode, and the unconnected mode UE receives the RS based on the bandwidth indicated by the RS configuration.

35. The method of claim 33, further comprising:
receiving, by the UE, bandwidth information of associated BWP of the connected mode UE for the RS configuration; and
determining, by the UE, a bandwidth for the RS transmission based on the bandwidth information.

36. The method of claim 1, wherein QCL information is indicated by TCI state, wherein each RS resource is QCL'ed with one SSB.

37. The method of claim 36, wherein a RS resource QCL'ed with one SSB has the same beam direction, beam width or both.

38. The method of claim 36, wherein a RS resource QCL'ed with one SSB has a first beam that is within a second beam of the SSB.

39. The method of claim 36, wherein multiple RS are QCL'ed with a same SSB.

40. The method of claim 36, wherein multiple RS resources are configured for multiple SSBs, each RS resource corresponding to a different SSB.

41. The method of claim 1, wherein the RS is transmitted with a wide beam.

42. The method of claim 1, wherein multiple RSs are received by the UE, and wherein each RS that is QCL'ed with the same SSB has the same beam.

43. The method of claim 1, wherein the RS transmission overlaps with a downlink transmission, and wherein the downlink transmission is a PDCCH transmission or a PDSCH transmission.

44. The method of claim 43, wherein the PDCCH transmission is a paging DCI transmission or a page indication (PI), and wherein the PDSCH transmission is a transmission scheduled by a paging DCI or a system information block (SIB).

45. The method of claim 43, further comprising:
determining, by the UE, that the RS transmission is not transmitted.

46. The method of claim 43, further comprising:
determining, by the UE, that the downlink transmission is punctured by or rate matched around the RS transmission.

47. The method of claim 43, further comprising:
determining, by the UE, that both the RS transmission and the downlink transmission are transmitted.

48. The method of claim 1, further comprising:
moving, by the UE while in the unconnected mode, from a first cell to another cell; and
switching, by the UE, to a second RS associated with the other cell for a tracking loop update and a measurement operation.

49. The method of claim 48, further comprising, after switching to the second RS:
use the RS associated with the first cell for neighbor cell measurement.

50. The method of claim 1, further comprising:
determining, by the UE, a quantity of a downlink channel condition;
comparing, by the UE, the quantity of the downlink channel condition to a threshold; and
receiving, by the UE, a second RS transmission from a single downlink transmission beam responsive to determining that the quantity of the downlink channel condition is greater than the threshold.

51. The method of claim 1, further comprising:
determining, by the UE, a quantity of a downlink channel condition;
comparing, by the UE, the quantity of the downlink channel condition to a threshold; and
receiving, by the UE, a second RS transmission from two or more downlink transmission beams responsive to determining that the quantity of the downlink channel condition is less than the threshold.

52. The method of claim 1, further comprising:
determining, by the UE, a quantity of a downlink channel condition for a downlink transmission beam associated with each SSB;
comparing, by the UE, the quantities of the downlink channel conditions associated with more than one SSB to determine a highest quantity of the downlink channel condition; and
selecting, by the UE, a particular SSB corresponding to the highest determined quantity of the downlink channel condition.

53. The method of any of claims 50-52, wherein the quantity of the downlink channel condition includes SINR, SNR, RSRP, RSRQ, or RSSI.

54. The method of claim 1, wherein the RS configuration includes a repetition setting, a number of port settings, a periodicity setting, a frequency domain density setting, and a power control offset settings.

55. The method of claim 54, wherein the repetition setting in the RS configuration is set to on.

56. The method of claim 54, wherein the number of port setting in the RS configuration is set to 1.

57. A method of wireless communication comprising:
determining, by a network entity, reference signal (RS) configuration settings for unconnected mode UEs;
generating, by the network entity, a RS transmission for unconnected mode UEs; and
transmitting, by the network entity, the RS transmission based on the RS configuration settings.

58. The method of claim 57, wherein the RS transmission is a connected mode RS.

59. The method of claim 57, wherein the RS transmission is a dedicated unconnected mode RS.

60. The method of claim 57, wherein the unconnected mode is a RRC inactive mode or RRC idle mode.

61. The method of claim 57, wherein the RS transmission is a CSI-RS.

62. The method of claim 62, wherein the RS transmission is a TRS.

63. The method of claim 57, further comprising:
transmitting, by the network entity, a paging message based on the RS transmission; and
transitioning, by the network entity, a particular UE from the unconnected mode to a connected mode based on the paging message.

64. The method of claim 57, further comprising:
transmitting, by the network entity, a broadcast message indicating the RS configuration settings.

65. The method of claim 57, further comprising:
transmitting, by the network entity, a RS configuration message indicating the RS configuration settings;
transmitting, by the network entity, a RS transmission; and
transmitting, by the network entity, a RRC release message.

66. The method of claim 65, wherein determining the RS configuration settings for the unconnected mode includes:
determining the RS configuration settings based on RS settings information for a connected mode.

67. The method of claim 65, wherein the RS configuration for the unconnected mode has a limited duration.

68. The method of claim 65, wherein the RRC release message includes an RS availability indication, and wherein determining the RS configuration settings for the unconnected mode includes: determining the RS configuration settings based on the RS availability indication.

69. The method of claim 65, further comprising:
transmitting, by the network entity, RS availability information in a message that is separate from the RRC release message, wherein determining the RS configuration settings for the unconnected mode includes: determining the RS configuration settings based on the RS availability information.

70. The method of claim 69, wherein the RS availability information indicates a particular RS resource from among a plurality of RS resources for connected mode devices, a particular RS resource set from among a plurality of RS resource sets for connected mode devices, an expiration time for the RS configuration for the unconnected mode, or a combination thereof.

71. The method of claim 65, wherein determining the RS configuration settings for the unconnected mode includes: determining the RS configuration settings based on network entity settings information and the RS configuration provided to devices in a connected mode.

72. The method of claim 65, further comprising:
transmitting, by the network entity, a RS configuration update message indicating an adjustment to a RS configuration.

73. The method of claim 65, further comprising:
determining, by the network entity, whether a RS configuration adjustment condition has been satisfied; and
adjusting, by the network entity, the RS configuration based on the RS configuration adjustment condition being been satisfied.

74. The method of claim 57, wherein a first sub-carrier spacing (SCS) of the RS transmission is the same as a second SCS of an active BWP of devices in the unconnected mode.

75. The method of claim 57, further comprising:
receiving, by the network entity, a RS configuration information indicating the RS configuration settings, wherein the RS configuration information does not include sub-carrier spacing (SCS) information.

76. The method of claim 57, wherein the RS is received in an overlapping bandwidth between a first bandwidth of the RS indicated by the RS configuration settings and a second bandwidth of an active BWP of an unconnected device.

77. The method of claim 57, further comprising:
receiving, by the network entity, a RS configuration information indicating the RS configuration settings, wherein the RS configuration information includes a carrier index information associated with a carrier on which the RS is transmitted.

78. The method of claim 57, wherein the RS is a CSI-RS or a TRS monitored by a connected mode device, wherein a starting resource block (RB) of an associated BWP of the connected mode device is not in steps of 4, and wherein bandwidth of associated BWP of the connected mode device is not in steps of 4.

79. The method of claim 78, further comprising modifying a bandwidth of a RS monitored by a connected mode device to a bandwidth having 4 RB granularity and a starting RB having 4 RB granularity for the RS configuration for the unconnected mode.

80. The method of claim 78, further comprising using a RS configuration for a connected mode as the RS configuration for the unconnected mode.

81. The method of claim 78, further comprising using bandwidth granularity of less than 4 RBs for the RS configuration for the unconnected mode device.

82. The method of claim 78, further comprising:
transmitting, by the network entity, bandwidth information of an associated BWP of the connected mode device for the RS configuration; and
determining, by the network entity, a bandwidth for the RS transmission based on the bandwidth information.

83. The method of claim 57, wherein the RS is a CSI-RS monitored by a connected mode device, and wherein a bandwidth of an associated BWP of the connected mode UE is less than 24 resource blocks (RBs).

84. The method of claim 83, further comprising using a RS configuration for a connected mode as the RS configuration for the unconnected mode, and the unconnected mode device receives the RS based on the bandwidth indicated by the RS configuration.

85. The method of claim 83, further comprising modifying a bandwidth for the RS configuration to be less than 24 RBs.

86. The method of claim 83, further comprising:
transmitting, by the network entity, bandwidth information of an associated BWP of the connected mode device for the RS configuration; and
determining, by the network entity, a bandwidth for the RS transmission based on the bandwidth information.

87. The method of claim 57, wherein the RS is a TRS monitored by a connected mode device, and wherein a bandwidth of an associated BWP of the connected mode device is less than 52 resource blocks (RBs).

88. The method of claim 87, further comprising using a RS configuration for a connected mode as the RS configuration for the unconnected mode, and the unconnected mode device receives the RS based on the bandwidth indicated by the RS configuration.

89. The method of claim 87, further comprising:
transmitting, by the network entity, bandwidth information of an associated BWP of the connected mode device for the RS configuration; and
determining, by the network entity, a bandwidth for the RS transmission based on the bandwidth information.

90. The method of claim 57, wherein QCL information is indicated by TCI state, wherein each RS resource is QCL'ed with one SSB.

91. The method of claim 90, wherein a RS resource QCL'ed with one SSB has the same beam direction, beam width or both.

92. The method of claim 90, wherein a RS resource QCL'ed with one SSB has a first beam that is within a second beam of the SSB.

93. The method of claim 90, wherein multiple RS are QCL'ed with a same SSB.

94. The method of claim 90, wherein multiple RS resources are configured for multiple SSBs, each RS resource corresponding to a different SSB.

95. The method of claim 57, wherein the RS is transmitted with a wide beam.

96. The method of claim 57, wherein multiple RSs are received by the UE, and wherein each RS that is QCL'ed with the same SSB has the same beam.

97. The method of claim 57, wherein the RS transmission overlaps with a downlink transmission, and wherein the downlink transmission is a PDCCH transmission or a PDSCH transmission.

98. The method of claim 97, wherein the PDCCH transmission is a paging DCI transmission or a page indication (PI), and wherein the PDSCH transmission is a transmission scheduled by a paging DCI or a system information block (SIB).

99. The method of claim 97, further comprising:
determining, by the network entity, that the downlink transmission is punctured by or rate matched around the RS transmission.

100. The method of claim 97, further comprising:
determining, by the network entity, to transmit the RS transmission and the downlink transmission are transmitted.

101. The method of claim 57, wherein the RS configuration includes a repetition setting, a number of port settings, a periodicity setting, a frequency domain density setting, and a power control offset settings.

102. The method of claim 101, adjusting the repetition setting in the RS configuration to on.

103. The method of claim 101, reducing a number of ports configured to 1.

104. An apparatus configured for wireless communication, the apparatus comprising:
a memory storing processor-readable code; and
at least one processor communicatively coupled to the memory, the at least one processor configured to:
operate, by a user equipment (UE), in an unconnected mode;
determine, by the UE, reference signal (RS) configuration settings for the unconnected mode;
monitor, by the UE, for a reference signal based on the RS configuration settings; and
receive, by the UE, a RS transmission in the unconnected mode based on the RS configuration settings.

105. The apparatus of claim 104, wherein the at least one processor is configured to execute the processor-readable code to cause the at least one processor to perform a method as in any of claims 1-56.

106. An apparatus configured for wireless communication, the apparatus comprising:
means for operating, by a user equipment (UE), in an unconnected mode;
means for determining, by the UE, reference signal (RS) configuration settings for the unconnected mode;
means for monitoring, by the UE, for a reference signal based on the RS configuration settings; and
means for receiving, by the UE, a RS transmission in the unconnected mode based on the RS configuration settings.

107. The apparatus of claim 106, wherein the apparatus includes one or more means configured to perform a method as in any of claims 1-56.

108. A non-transitory computer-readable medium storing instructions that, when executed by a processor, cause the processor to perform operations comprising:
operating, by a user equipment (UE), in an unconnected mode;
determining, by the UE, reference signal (RS) configuration settings for the unconnected mode;
monitoring, by the UE, for a reference signal based on the RS configuration settings; and
receiving, by the UE, a RS transmission in the unconnected mode based on the RS configuration settings.

109. The non-transitory, computer-readable medium of claim 108, wherein the operations further include one or more operations of a method as in any of claims 1-56.

110. An apparatus configured for wireless communication, the apparatus comprising:
a memory storing processor-readable code; and
at least one processor communicatively coupled to the memory, the at least one processor configured to:
determine, by a network entity, reference signal (RS) configuration settings for unconnected mode UEs;
generate, by the network entity, a RS transmission for unconnected mode UEs; and
transmit, by the network entity, the RS transmission based on the RS configuration settings.

111. The apparatus of claim 110, wherein the at least one processor is configured to execute the processor-readable code to cause the at least one processor to perform a method as in any of claims 57-103.

112. An apparatus configured for wireless communication, the apparatus comprising:
means for determining, by a network entity, reference signal (RS) configuration settings for unconnected mode UEs;
means for generating, by the network entity, a RS transmission for unconnected mode UEs; and
means for transmitting, by the network entity, the RS transmission based on the RS configuration settings.

113. The apparatus of claim 112, wherein the apparatus includes one or more means configured to perform a method as in any of claims 57-103.

114. A non-transitory computer-readable medium storing instructions that, when executed by a processor, cause the processor to perform operations comprising:
determining, by a network entity, reference signal (RS) configuration settings for unconnected mode UEs;
generating, by the network entity, a RS transmission for unconnected mode UEs; and
transmitting, by the network entity, the RS transmission based on the RS configuration settings.

115. The non-transitory, computer-readable medium of claim 114, wherein the operations further include one or more operations of a method as in any of claims 57-103.
